(19) United States
(12) Patent Application Publication
(10) Pub. No.: US 2020/0232142 A1
(43) Pub. Date: Jul. 23, 2020

(54) WASHING AND/OR DRYING MACHINE

(71) Applicant: Vestel Elektronik Sanayi ve Ticaret A.S., Manisa (TR)

(72) Inventors: Onur ULUAG, Manisa (TR); Kivanç KABASAKAL, Manisa (TR)

(21) Appl. No.: 16/632,297

(22) PCT Filed: Dec. 27, 2017
(86) PCT No.: PCT/EP2017/084657

§ 371 Date: Jan. 17, 2020

(30) Foreign Application Priority Data
Jul. 24, 2017 (EP) 17182862.7

(51) Int. Cl. D06F 37/30; D06F 25/00; D06F 34/10; D06F 58/08; H02P 6/30

(52) U.S. Cl. CPC D06F 37/304; D06F 25/00; D06F 2103/24; D06F 58/08; H02P 6/30; D06F 34/10

(57) ABSTRACT

A washing and/or drying machine comprises a main body portion and a drum located within the main body portion. The drum comprises an open end for receiving garments placed in the drum and a closed end for containing the garments within the drum, the closed end being opposite the open end. The drum comprises a side portion connecting the open end to the closed end. The drum comprises at least one magnet located on the side portion of the drum, for magnetic interaction with a corresponding at least one electromagnet in the main body portion of the washing machine. There is further provided a controller for controlling electrical current supplied to the at least one electromagnet so as to control a magnetic field to which the at least one magnet on the drum is subjected. This enables the controller to control movement of the drum, in use.

### CROSS REFERENCE TO RELATED APPLICATION

This application is a US 371 application from PCT/EP2017/084657 entitled “Washing and/or Drying Machine” filed on Dec. 27, 2017 and published as WO 2019/020206 A1 on Jan. 31, 2019, which claims priority to EP Application 17182862.7 filed on Jul. 24, 2017. The technical disclosures of every application and publication listed in this paragraph are hereby incorporated herein by reference.

### TECHNICAL FIELD

The present disclosure relates to a washing and/or drying machine.

### BACKGROUND

Washing machines are used for washing garments such as clothes. Drying machines are used for drying wet garments. Combined washer/dryer machines may also be provided. Typically a user can select a suitable washing and/or drying cycle via an interface on a front face of the machine. A user places garments to be washed or dried in to a drum of the machine. The drum is caused to rotate during a washing or drying cycle.

### SUMMARY

According to a first aspect disclosed herein, there is provided a garment washing and/or drying machine comprising: a main body portion; a drum located within the main body portion, the drum comprising an open end for receiving garments placed in the drum and a closed end for containing the garments within the drum, the closed end being opposite the open end and the drum comprising a side portion connecting the open end to the closed end, the drum configured for rotation about a rotational axis of the drum; the drum comprising at least one magnet located on the side portion of the drum, for magnetic interaction with a corresponding at least one electromagnet in the main body portion of the washing machine; and a controller for controlling electrical current supplied to the at least one electromagnet so as to control a magnetic field to which the at least one magnet on the drum is subjected, enabling the controller to control movement of the drum, in use.

According to an example, the controlling movement of the drum comprises controlling rotational movement of the drum about its rotational axis.

According to an example, the controlling movement of the drum comprises controlling translational movement of the drum along its rotational axis.

According to an example, the machine comprises a frame within the main body portion.

According to an example, the machine comprises a stator assembly attached to the frame, the at least one electromagnet comprised in the stator assembly.

According to an example, the stator assembly is arranged to substantially surround the drum, the stator assembly comprising a generally circular inner periphery to complement a cylindrical shape of the drum.

According to an example, the at least one electromagnet is comprised on the frame.

According to an example, the machine comprises a position sensor for sensing a position of the drum in the machine.

According to an example, the position sensor comprises a magnetic field sensor, a determined magnetic field strength being indicative of the position.

According to an example, the magnetic field sensor comprises the at least one electromagnet and/or the at least one magnet located on the drum.

According to an example, the controller is configured to use position information received from the position sensor so as to control the movement of the drum.

According to an example, the at least one electromagnet comprises a plurality of windings operable in a 3-phase configuration.

According to an example, the at least one magnet located on the side portion of the drum comprises a plurality of permanent magnets.

According to an example, each of the plurality of magnets extends longitudinally along the side portion of the drum, between the closed end and the open end.

According to an example, the machine comprises a bearing assembly for supporting a shaft of the drum, the bearing assembly comprising one or more of: a rotational bearing; a thrust bearing.

### BRIEF DESCRIPTION OF THE DRAWINGS

To assist understanding of the present disclosure and to show how embodiments may be put into effect, reference is made by way of example to the accompanying drawings in which:

FIG. 1 shows schematically a washing machine according to an example;

FIG. 2 shows schematically a prior art drum-drive assembly;

FIG. 3 shows schematically another prior art drum-drive assembly;

FIG. 4 schematically shows a drum-drive assembly for a washing and/or drying machine according to an example;

FIG. 5 schematically shows a drum of a washing and/or drying machine according to an example, in use.

### DETAILED DESCRIPTION

The present disclosure has applicability to garment washing machines, garment drying machines, or combined washing/drying machines. In the foregoing description the term “washing machine” or simply “machine” may be used, however it will be understood that any such reference is also applicable to a drying machine (e.g tumble dryer) or a combined washer/dryer, unless specifically stated otherwise. The terms “garments” and “clothes” may also be used interchangeably.

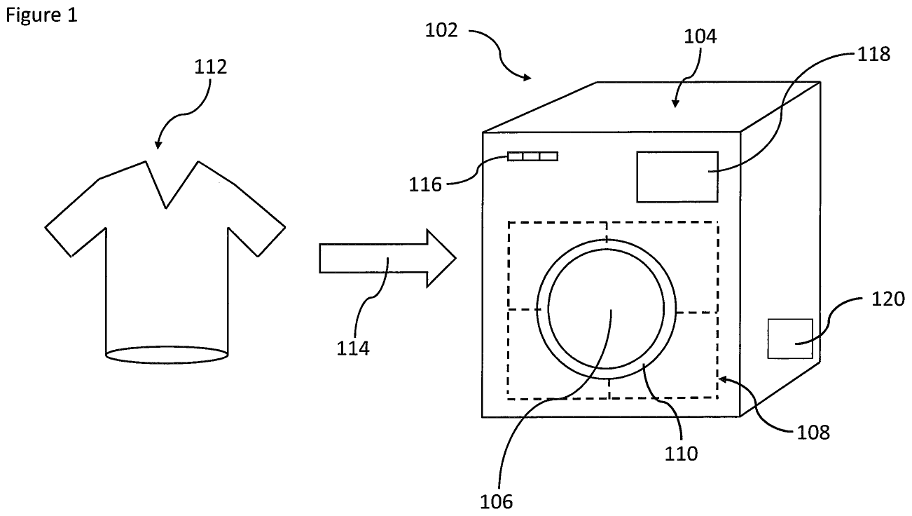

FIG. 1 shows an example washing and/or drying machine 102. The machine 102 comprises a main body portion 104. Within the main body portion 104 there is located a drum 106. Typically the drum is cylindrical and is controlled to rotate during a washing and/or drying cycle. To this end a motor (not shown) is provided to provide the motive force to rotate the drum. The drum 106 is supported by a frame within the main body portion 104. The frame is schematically shown with the dashed lines 108. A window or door 110 is also provided to close off the drum during use of the machine 102.

A power connector is shown at 120. The power connector 120 enables the machine 102 to be connected to mains power for electrically powering the machine 102.

A user can place a garment to be washed or dried 112 in to the drum 106 prior to a washing or drying cycle. This is schematically represented by arrow 114. Although in FIG. 1 the garment is shown as a T-shirt it will of course be understood that the garment may be any type of garment such as a shirt, jumper, trousers, underwear, skirt, shoes etc. The term garment may also include any other type of washable object such as sheets, pillowcases etc. That is the term “garment” may be interchangeable with the term “item” or “object”.

The user can control functions of the washing machine via user interface 116, such as selecting a desired cycle. The user interface may comprise one or more buttons. A display 118 may also be provided. The display 126 may provide information to a user such as available cycles, time remaining of a cycle etc.

As discussed above, in use the drum of the washing machine is controlled to rotate. The speed of rotation may also be controlled. A motor is provided to provide the rotational force to the drum.

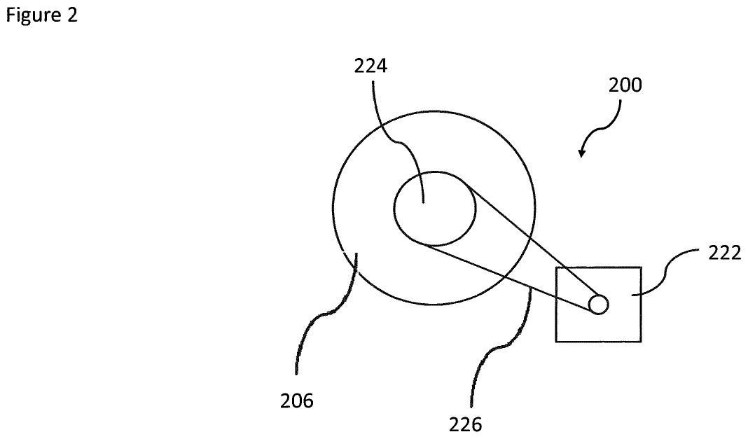

FIG. 2 shows a prior art example of a motor assembly for rotating a drum 206 of a washing/drying machine. The motor assembly is shown generally at 200. The motor assembly comprises a motor 222 connected to a pulley wheel 224 via a belt 226. The pulley wheel 224 is fixed to drum 206, such that rotation of pulley wheel 224 causes a corresponding rotation of drum 206. The present inventors have realised that such an arrangement can cause undesirable vibrations of the drum 206, in use, due to the unevenly distributed mass of the drum (for example due to the additional weight of the pulley wheel 224 at one end thereof). This uneven weight distribution may also cause translational movement of the drum along the axis of rotation of the drum, which may again lead to undesirable vibrations. The “pulling” effect of the belt may also cause vibrations of the drum.

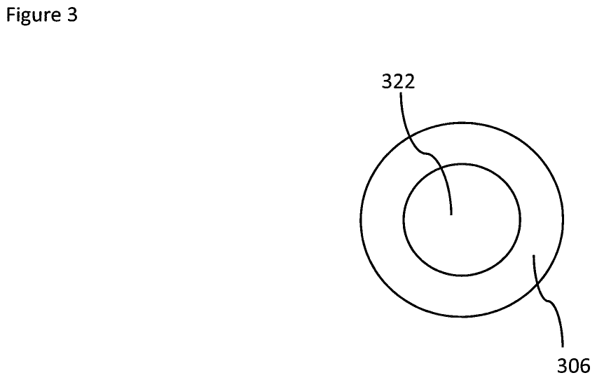

FIG. 3 shows a further prior art example of a “direct-drive” washing machine drum 306. In this example a motor 322 is connected directly to the back of the drum 306, to cause rotation thereof in use. This system eliminates vibrations caused by the belt in the motor assembly of FIG. 2, but as realized by the present inventors reduces the available depth of the drum 306 due to the space required to accommodate the motor 322 at the back of the drum. This has an effect of reducing the available capacity of the drum 306. Furthermore, undesirable vibrations are still a problem in the system of FIG. 3, and further suspension components such as dampers may be required in order to damp those vibrations.

In an example embodiment a washing and/or drying machine is provided in which a motor assembly is provided in which the motor is located outside of the drum, such that at least a portion of the drum is enclosed by the motor. By way of explanation the overall assembly may be considered to comprise a rotor and stator assembly, in which the drum itself comprises the rotor.

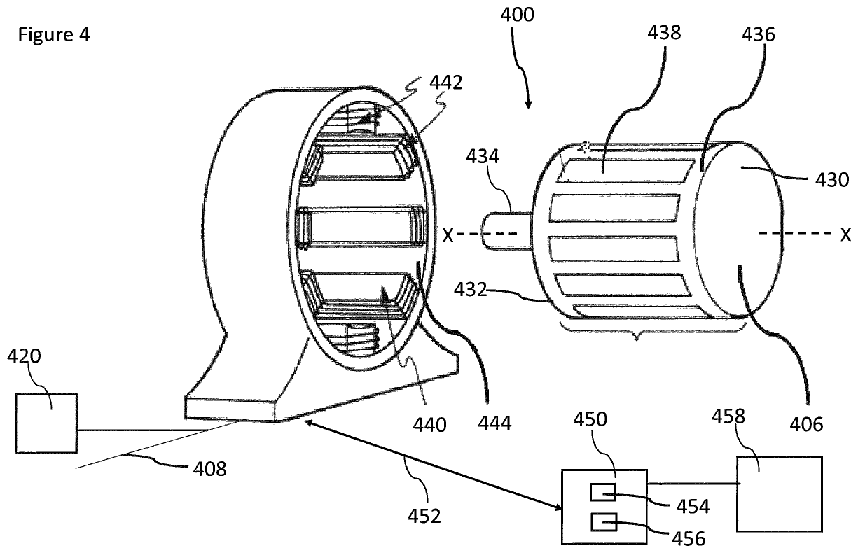

This will be explained in more detail with respect to FIG. 4 which shows an example drum drive-assembly 400. A drum 406 comprises an open end 430 and a closed end 432. The closed end 432 is opposite the open end 430. The open end 430 is arranged so as to be positioned proximate to a door of a washing machine when located therein. The open end 430 enables clothes or other garments to be placed in to an interior of the drum 406. The closed end is “closed” in as much as it prevents garments from passing through or falling out of the closed end 432. However it will be understood that in some embodiments the closed end may include, for example, one or more perforations or holes or the like to enable water or air to pass through closed end 432. A shaft 434 is provided which projects from closed end 432. When located in a suitable washing machine the shaft 434 is located in a suitable bearing assembly of the washing machine, to support rotation and/or translational movement of the drum about and/or along its rotational axis X-X. The bearing assembly may comprise a roller bearing for enabling and supporting the rotation of the shaft 434, and/or a thrust bearing for enabling and supporting the translational movement of the shaft 434.

A side 436 of the drum 406 connects and extends between the closed end 432 and the open end 430. An outer surface of the side 436 is parallel or substantially parallel to the axis of rotation X-X. The side 436 comprises at least one magnet 438. In this example the at least one magnet 438 comprises a plurality of magnets. Each magnet extends along the side 436 in a direction parallel to rotational axis X-X. In this example each magnet comprises a permanent magnet. In this example the at least one magnet 438 is located on an outer surface of the side 438. However in other examples the at least one magnet 438 may be positioned on an inside surface of side 436 or embedded within side 436.

A stator assembly is schematically shown at 440. In this example the stator 440 is attached to a frame 408 of the washing machine. The stator comprises at least one electromagnet 442. In this example the at least one electromagnet 442 comprises a plurality of electromagnets. The at least one electromagnet 442 may be a coil. The at least one electromagnet may comprise a plurality of windings operable in a 3-phase configuration. In this example the stator 440 comprises a circular inner periphery 444 to complement the cylindrical shape of the drum 406. Although FIG. 4 shows the drum (or rotor) 406 and stator 440 in a separate and exploded fashion for ease of understanding, it will be understood that in use the drum 406 is positioned within, or at least partially within, an interior of the stator 440. That is it may be considered that the drum 406 is encircled or surrounded by the motor or stator 440. The drum drive assembly is also operably connected to a suitable power source shown schematically at 420. The power source 420 is operable to supply electrical current to the at least one electromagnet 442.

It will be understood that the construction of the stator shown in FIG. 4 is by way of example only and that in other embodiments different constructions or arrangements may be used. For example, in one example, the stator may consist of one or more electromagnets positioned on the frame 408 of the washing machine.

A controller, shown schematically at 450, is in communication with (as represented by arrow 452), and operable to control drum-drive assembly 400. The controller comprises memory 454 and a processor 456. The controller 450 can control the current supplied to the at least one electromagnet 442. Supplying current to the electromagnet 442 creates a magnetic field in the vicinity of the stator 442. The at least one magnet 438 on the drum 406 is subject to this magnetic field, which accordingly causes movement of the drum 406 due to magnetic interaction between magnet 438 and the magnetic field. Accordingly the controller 450 can control movement of the drum 406. The movement of the drum can be rotational i.e. about axis X-X, in a clockwise or anticlockwise direction. Translational movement of the drum 406 (i.e. in a direction parallel to axis X-X) may also be controlled by the controller 450. The translational movement may be inward movement i.e. movement of the drum 406 towards the stator 440 when viewing FIG. 4; or outward movement i.e. movement of the drum 406 away from the stator 440 when viewing FIG. 4. For controlling translational movement of the drum 406, the two-dimensional position may be controlled relative to a reference point (0,0), which in one example is the axis X-X. The controller 450 can selectively control the direction of rotation (e.g. clockwise/anticlockwise) and/or direction of translation (e.g. inward or outward). The controller may achieve this, for example, by selectively powering of the electromagnets 442 (where there is a plurality of electromagnets) and/or by selective powering of one or more regions of the one or more electromagnets 442, and/or by adjusting the magnitude of supplied current to the electromagnets.

The controller is also in communication with a position sensor shown schematically at 458. Using the position sensor the controller 458 can determine a position of the drum 406. The positional information may pertain to a rotational and/or translational position of the drum 406. In some embodiments the position sensor 458 comprises the at least one electromagnet 442 and/or at least one magnet 438 on the drum 406, or the position sensor 458 comprises a magnetic field sensor proximate to the at least one electromagnet 442 and/or at least one magnet 438 on the drum 406. Positional information of the drum 406 can be determined based on a determined strength or magnitude of the magnetic field. Of course, in other examples different types of position sensors may be used in order to obtain the positional information of the drum 406. One or more optical sensors may be used in this respect, for example.

There is therefore provided a feedback loop, enabling the controller 450 to ascertain position information of the drum 406 and to control movement of the drum 406 accordingly. The movement of the drum 406 can therefore be controlled in order to control or reduce vibration of the drum 406 in the washing machine.

In some examples the stator 440 is unitary, and can be installed in the washing machine in one piece. Alternatively the stator 440 may comprise separate components which can be installed separately in the washing machine. For example the stator may comprise separate electromagnetic coils attached to the frame 408 in the washing machine. In such an implementation the frame may be considered to comprise the stator.

Together, the drum (or rotor) 406 and stator 440 may be considered to form a brushless direct current (BLDC) motor arrangement. In one example the drum 406 is connected to the stator 440 via a revolute joint, the stator 440 surrounding the drum 406.

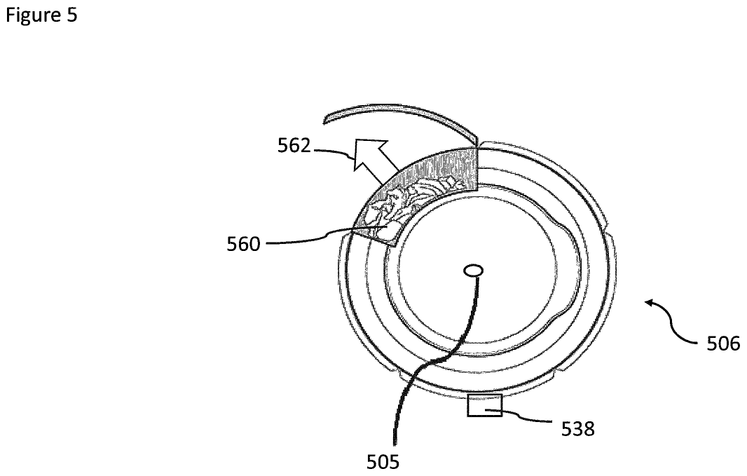

FIG. 5 schematically shows a drum 506 of a washing and/or drying machine. The drum 506 is in use and rotating about a central axis 505. Garments 560 and water are pushed to the outer edge of the drum by virtue of centrifugal force which is schematically shown by arrow 562. The centrifugal force generated is affected by the centre-of-gravity (or inertia axis) of the drum 506. At least one magnet 538 is provided on the side of the drum 506 in a manner as explained with respect to FIG. 4. Due to a relatively increased mass of the drum 506, caused by the at least one magnet 538, the effect of weight of laundry (e.g. garments) and water to centre of gravity is reduced, meaning that the inertia axis becomes more centralized in the drum, which causes the centrifugal force 562 to be relatively reduced.

It will be understood that the examples described do not require a belt-drive assembly as shown in the prior art example of FIG. 2. Accordingly the examples described do not suffer from the vibrational issues associated with such belt-drive assemblies. Furthermore, and in comparison with the prior art example of FIG. 3, the embodiments described herein do not require a motor assembly to be provided behind the drum. Accordingly more space is available enabling a relatively deeper drum to be used which can increase washing and/or drying capacity.

By placing the magnets on the outside of the drum, as shown for example in FIG. 4, relatively more torque can be applied since it is applied to the drum radius. This may enable faster spin speeds of the drum, and/or faster acceleration and/or deceleration of the drum. This arrangement may also provide smoother power transmission to the drum, in use.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors and a digital signal processor or processors, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A garment washing and/or drying machine comprising:
a main body portion;
a drum located within the main body portion, the drum comprising an open end for receiving garments placed in the drum and a closed end for containing the garments within the drum, the closed end being opposite the open end and the drum comprising a side portion connecting the open end to the closed end, the drum configured for rotation about a rotational axis of the drum;
the drum comprising at least one magnet located on the side portion of the drum, for magnetic interaction with a corresponding at least one electromagnet in the main body portion of the washing machine; and
a controller for controlling electrical current supplied to the at least one electromagnet so as to control a magnetic field to which the at least one magnet on the drum is subjected, enabling the controller to control movement of the drum, in use.

2. A garment washing and/or drying machine according to claim 1, the controlling movement of the drum comprising controlling rotational movement of the drum about its rotational axis.

3. A garment washing and/or drying machine according to claim 1, the controlling movement of the drum comprising controlling translational movement of the drum along its rotational axis.

4. A garment washing and/or drying machine according to claim 1, comprising a frame within the main body portion.

5. A garment washing and/or drying machine according to claim 4, the machine comprising a stator assembly attached to the frame, the at least one electromagnet comprised in the stator assembly.

6. A garment washing and/or drying machine according to claim 5, the stator assembly arranged to substantially surround the drum, the stator assembly comprising a generally circular inner periphery to complement a cylindrical shape of the drum.

7. A garment washing and/or drying machine according to claim 4, the at least one electromagnet comprised on the frame.

8. A garment washing and/or drying machine according to claim 1, comprising a position sensor for sensing a position of the drum in the machine.

9. A garment washing and/or drying machine according to claim 8, the position sensor comprising a magnetic field sensor, a determined magnetic field strength being indicative of the position.

10. A garment washing and/or drying machine according to claim 9, the magnetic field sensor comprising the at least one electromagnet and/or the at least one magnet located on the drum.

11. A garment washing and/or drying machine according to claim 8, the controller configured to use position information received from the position sensor so as to control the movement of the drum.

12. A garment washing and/or drying machine according to claim 1, wherein the at least one electromagnet comprises a plurality of windings operable in a 3-phase configuration.

13. A garment washing and/or drying machine according to claim 1, wherein the at least one magnet located on the side portion of the drum comprises a plurality of permanent magnets.

14. A garment washing and/or drying machine according to claim 13, wherein each of the plurality of magnets extends longitudinally along the side portion of the drum, between the closed end and the open end.

15. A garment washing and/or drying machine according to claim 1, the machine comprising a bearing assembly for supporting a shaft of the drum, the bearing assembly comprising one or more of: a rotational bearing; a thrust bearing.
